(19) United States
(12) Patent Application Publication
(10) Pub. No.: US 2021/0406973 A1
(43) Pub. Date: Dec. 30, 2021

(54) INTELLIGENT INQUIRY RESOLUTION CONTROL SYSTEM

(71) Applicant: MASTERCARD INTERNATIONAL INCORPORATED, Purchase, NY (US)

(72) Inventors: Kinneret Nahamani, North Miami Beach, FL (US); Narendra Babu Dukkipati, Dardenne Prairie, MO (US); Donna M. Terman, Patterson, NY (US); Wendy P. Richardson, Lake Saint Louis, MO (US); Shelly Lynette Morrison, Wicklow (IE)

(21) Appl. No.: 17/363,711

(22) Filed: Jun. 30, 2021

Related U.S. Application Data
(60) Provisional application No. 63/046,605, filed on Jun. 30, 2020.

(51) Int. Cl. G06Q 30/06; G06F 16/16; G06F 16/23; G06F 40/205

(52) U.S. Cl. CPC G06Q 30/0623; G06F 40/205; G06F 16/23; G06F 16/164

(57) ABSTRACT

Aspects of the disclosure provide a computerized method and system that intelligently selects a qualified agent who is available to timely resolve a client issue that was expressed to a processor in a free form natural language communication. In examples, agent selection is accomplished from beginning to end, free from human involvement. Further, unique feedback functionalities are provided, which improve selection functionality by electronically recognizing trending resolution preferences and adapting the provided computerized method and system based thereon.

### CROSS-REFERENCE TO RELATED APPLICATION(S)

This application claims the benefit of U.S. Provisional Application No. 63/046,605 filed Jun. 30, 2020, entitled “Intelligent Inquiry Resolution Control System”, the entirety of which is hereby incorporated by reference herein.

### BACKGROUND

Receiving customer questions and/or complaints about products and/or services has historically been frustrating for clients and arduous for product and service providers. Systems and methods that better identify who, within a product and service provider, is available and competent to handle client questions and/or complaints would improve a customer's experience and relieve much of the burden typically endured by product and service providers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for intelligently controlling resolution seeking inquiries. The method may include receiving, by one or more processors, a data file including natural language from an inquiry drafted by a client and parsing, by the one or more processors, natural language fields of the data file to identify at least one issue described by client drafted natural language. Responsive at least to metadata of the data file and the identified at least one issue, methods may further determine, by the one or more processors, parameters and context corresponding to the identified at least one issue, and create, by the one or more processors, an electronic case file comprising at least part of the data file and identifying the at least one issue, wherein creation of the electronic case file triggers the one or more processors select at least one agent of a plurality of agents for assignment to the created electronic case file. In examples, the method receives, by the one or more processors from one or more data repositories, data quantifying qualifications of ones of the plurality of agents; receiving, by the one or more processors from the one or more data repositories, data quantifying conditions of ones of the plurality of agents, and execute, by the one or more processors, a test that outputs selected ones of the plurality of agents for the created electronical case file based at least on the context and the determined parameters of the identified at least one issue, and the data quantifying the qualifications and the data quantifying conditions. The method also updates, by the one or more processors, a data field of the electronic case file indicating the selected at least one agent, wherein the selected at least one agent is configured to resolve the identified at least one issue.

### BRIEF DESCRIPTION OF THE DRAWINGS

The present description will be better understood from the following Detailed Description read in light of the accompanying drawings, wherein:

FIG. 1 is a block diagram illustrating a system configured for intelligently controlling resolution seeking inquiries according to an example;

FIG. 2 is a block diagram illustrating a system configured for intelligently controlling resolution seeking inquiries according to an example;

FIG. 3 is a block diagram illustrating a system configured for intelligently controlling resolution seeking inquiries according to an example;

FIG. 4 is a diagram illustrating data conversion examples and parameter fields of a system configured for intelligently controlling resolution seeking inquiries according to an example;

FIG. 5 is a diagram illustrating data conversion examples and context fields of a system configured for intelligently controlling resolution seeking inquiries according to an example;

FIG. 6 is a diagram illustrating an example agent qualifications data repository scheme configured for intelligently controlling resolution seeking inquiries according to an example;

FIG. 7 is a diagram illustrating an example agent conditions data repository scheme configured for intelligently controlling resolution seeking inquiries according to an example;

FIG. 8 is a flow chart illustrating a computerized method, from an example case management system perspective, for intelligently controlling resolution seeking inquiries according to an example;

FIG. 9 is a flow chart illustrating a computerized method, from an example intelligent delegation system perspective, for intelligently controlling resolution seeking inquiries according to an example;

FIG. 10 is a flow chart illustrating a computerized method for machine training an example intelligent delegation system according to an example; and

FIG. 11 illustrates a computing apparatus according to an example as a functional block diagram.

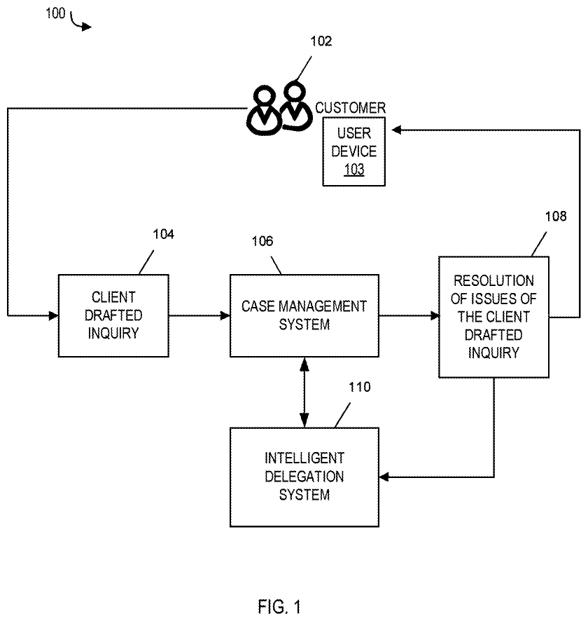

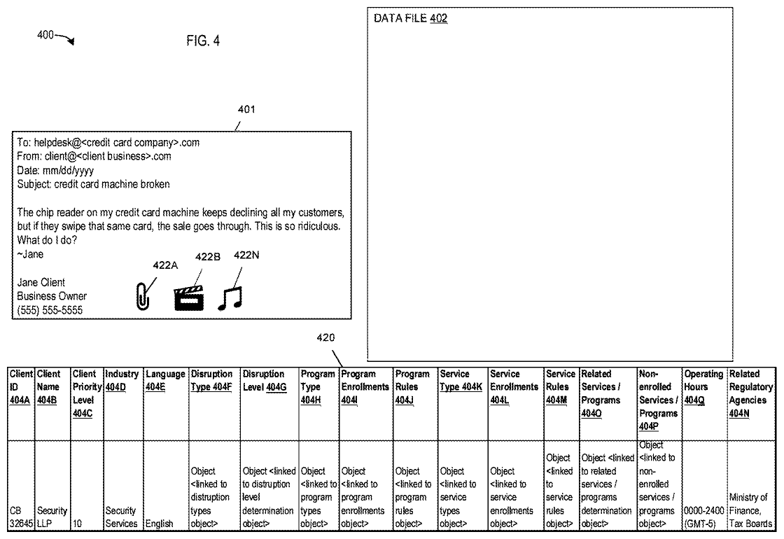

Corresponding reference characters indicate corresponding parts throughout the drawings. In FIGS. 1 to 3 and 11, the systems are illustrated as schematic drawings. The drawings may not be to scale. The features and functions of FIGS. 4-10 are configured to operate with any systems of FIGS. 1 to 3 and 11.

### DETAILED DESCRIPTION

Aspects of the disclosure provide a computerized method and system that intelligently selects a qualified agent who is available to timely resolve a client's issue that was expressed to a processor in a free form natural language communication. In examples, agent selection is accomplished from beginning to end free from human involvement starting at the moment a processor receives a communication from the client, through the process of selecting an appropriate agent, and ending the moment the selected agent begins resolving the client's issue.

In instances, processors of a case management system receive a client drafted inquiry that expresses one or more issues using natural language, for example, a free form email. Responsive to receiving the client drafted inquiry, the processor converts information of the free form email into a data file formatted to be understandable by a machine trained intelligent delegation system that is operable to parse natural language. Upon the intelligent delegation system receiving the data file, which includes a client's natural language expression of one or more issues, processors of intelligent delegation system identify issues from the natural language, determine context of the inquiry and issues, and determine parameters that affect the client and their identified issues.

In selecting a qualified agent who is available to resolve the identified issues, the intelligent delegation system receives qualification information about a pool of agents as well as information about conditions of the pool of agents. Using the agent qualification information, agent conditions information, context of the inquiry and issues, and parameters determined to affect the client and the issues, the intelligent delegation system executes a test to select one or more qualified agents and/or agent teams who are available to resolve the identified issues. Further, the intelligent delegation system weights various inputs of the test in order to select agents that are most likely to provide a resolution that provides high satisfaction for the client based on previous resolutions that previously satisfied this specific client as well as identified characteristics of the selected agent which indicate the client and agent will likely connect on a personal level.

The disclosure addresses the challenges of conventional client inquiry systems, which typically expend more time selecting an appropriate agent for each client issue than the amount of time an agent takes to resolve a client's issue. Reducing the time spent during agent selection reduces resource usage and network congestion.

The disclosure operates in an unconventional way at least by accepting free form natural language communications as opposed to traditional structured forms that force clients to select from limited issue lists. Since clients prefer free form natural language communications, functionality of systems and methods described herein are improvements over traditional systems because the functionality improves a client's experience by making the client feel fully heard, which immediately begins diffusing angry or frustrated clients experiencing irksome issues.

Further, because functionality of systems and methods described herein provide a forum for clients to express their aggravations and annoyances, an agent selected to resolve the issue is better informed, via client history information, and better able to prepare for a client interaction with predetermined solution opinions, which increases issue resolution speed, increases the probability of resolution satisfaction, and saves agents from first being subjected to negative discourse before solution opinions can be determined by the agent. Such improvements reduce resource usage, especially network congestion, by reducing the amount of time an agent and client interact on a call and/or messaging system. Moreover, reducing the amount of time an agent and client interact on a call and/or messaging system leads to a further reduction in resource usage because hold times for other clients are significantly reduced by the reducing of agent and client interactions as well as having the client wait for their agent and client interaction while offline.

Systems and methods disclosed herein include feedback functionality that dynamically updates information in data repositories and is used to modify the computer program code that selects an agent. The use of such feedback functionality improves the efficiency and accuracy of computing devices that perform agent selection by modifying the computer's agent selection functionality based on new and up-to-date information learned about agents, clients, issues, successful resolutions, and unsuccessful solution offers. Modifying the computer's agent selection functionality improves the computer by keeping the computer's programming current and responsive to clients' trending preferences while avoiding the typical lag time and personal costs caused by human programmers. Further, computing devices that are modified to perform the agent selection modification disclosed herein reduce system down time that is typically caused by conventional software updates and new software releases. Further still, the unique feedback functionalities disclosed herein improve a typical computing device's selection functionality by providing computer functionality that executes software which recognizes and adapts to trending resolution preferences more quickly, efficiently, and seamlessly as compared to traditional computers that rely on human coded software updates and patches.

Further still, example systems and methods herein provide functionality the allows agent systems to modify and update agent data repositories, which provides increased data accuracy and quicker updating while also offloading processing resources to agent systems, which frees computing resources of the agent selecting processors enabling them to perform agent selection more quickly. Likewise, example systems and methods herein provide functionality that prevents agent systems from modifying or updating client data repositories which reduces inaccuracies that could otherwise be caused by unintentional or nefarious data modifications by entities lacking sufficient knowledge to accurately modify data stored therein, while also improving data security by preventing agent systems from accessing client data of clients to whom the agent is providing no issue resolution services.

FIG. 1 is a block diagram illustrating a system configured for intelligently controlling resolution seeking inquiries according to an example. System 100 includes a plurality of computerized systems exchanging information over a communications network, e.g. the Internet.

A customer 102 of the system may utilize user device 103 (e.g., laptop, smart phone, personal computer, tablet, laptop, server, or other computing device) to create a client drafted inquiry 104. The client drafted inquiry may include natural language drafted in free form. Free form construction is distinguishable from non-free form construction, which guides and/or restricts topics from which a user may select and/or restricts input types and/or structures that are compatible with the system. For example, traditional online inquires often have drop down menus listing topics from which a client selects before moving to the next field of an inquire form. In other examples, conventional inquires include templates within which restricted types of input data and/or amounts of input data. In contrast, client drafted inquiry 104 is free from a predefined form and/or template, includes natural language, and may be of any electronically communicable type, including, but not limited to, emails, voicemails, videos, test messages, images with or without annotations, and the like.

User device 103 may send client drafted inquiry 104 to case management system 106 via a communications network. Case management system 106 converts the client drafted inquiry into a data format that is understandable by intelligent delegation system 110. Upon data received from the client being converted, case management system 106 sends the converted data to intelligent delegation system 110, which performs several operations to intelligently determine how and where to disseminate information and issues extracted from the client drafted inquiry to systems and agents with the goal of resolving the customer's inquiries in a manner that most satisfied that particular customer. Upon delegating how and where to disseminate information and issues extracted from the client drafted inquiry, intelligent delegation system 110 sends the delegation information to case management system 106, which manages and effectuates the determinations made by intelligent delegation system 110.

Responsive to a resolution, one or more resolutions of one or more issues of the client drafted inquiry 108 are sent to the user device 103 to realize client satisfaction. Further, resolutions of one or more issues of the client drafted inquiry 108 are fed back to the intelligent delegation system 110, converted into training data, and used to improve the processes performed by intelligent delegation system 110.

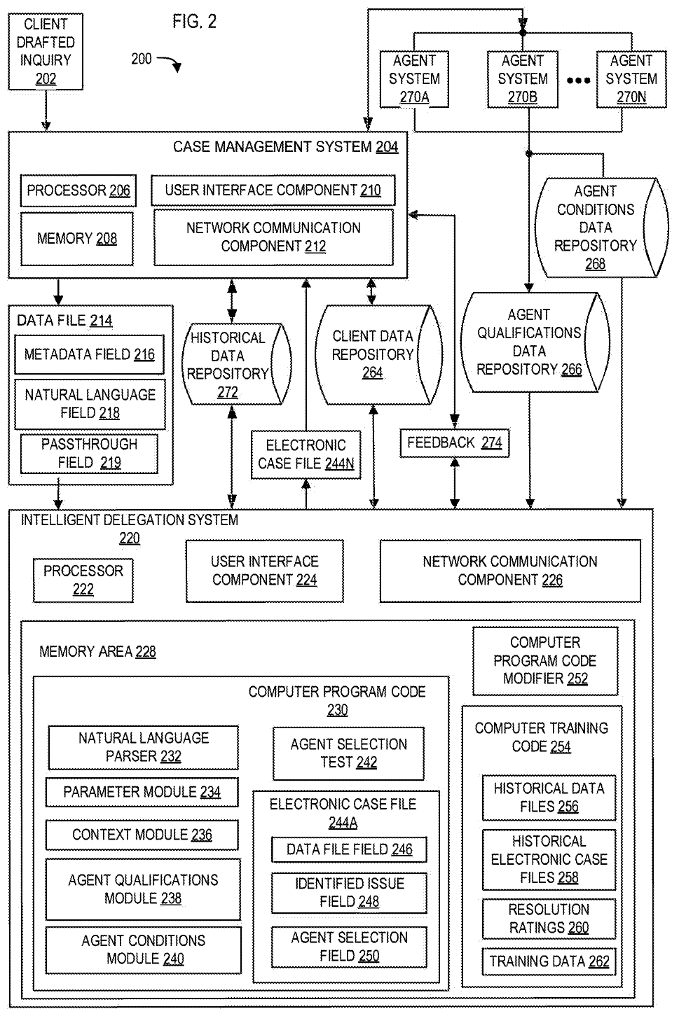

FIG. 2 is a block diagram illustrating a system configured for intelligently controlling resolution seeking inquiries according to an example. System 100 includes a plurality of computerized systems exchanging information over one or more communications networks, e.g. the Internet, Intranet, WLANs, LANs, wired and/or wirelessly, cellular networks, and the like. In example, parts or all the system may operate as a cloud-based system or partially cloud based system.

A customer user device may electronically send a client drafted inquiry 104 to a case management system 204. Case management system 204 includes at least one processor 206, which may be locally situated and/or remotely distributed. Processor 206 communicates with one or more local and/or remote memory 208, which at least stores computer executable code causing processor 206 to perform operations. Case management system 204 also include user interface component 210 and network interface component 212, both of which receive and send input and output.

Case management system 204 receives client drafted inquiry 104 including information drafted by a client and may include natural language expressed in free form. Processor 206 executes computer executable code stored on non-transitory memory 208 which causes processor 206 to extract information from client drafted inquiry 202 and convert the extract information into data file 214. During the conversion, the information is reformatted into a format that is understandable by an application programming interface (API) of intelligent delegation system 220 for data file 214, and the data file 214 is encoded for transmission according to a communication protocol that is decodable by the API of intelligent delegation system 220.

Data file 214 includes fields including natural language field 218 comprising natural language extracted from portions of client drafted inquiry 202. In examples, natural language field 218 may include natural language from a body of an email and/or subject line of an email. In other examples, natural language field 218 may include natural language from a spoken portion of a voicemail. Further, natural language field 218 may include natural language from a spoken portion of a video and/or words extracted from images of the video. Further still, natural language field 218 may include natural language extracted from annotated portions of an image and/or words extracted from portions of the image.

Data file 214 includes additional fields, for example, metadata field 216 extracted from portions of the client drafted inquiry 202. In examples, location information such as the point of origin of the client drafted inquiry 202, company and/or account information associated with client drafted inquiry 202, inquiry format information (e.g., email, voicemail, video, image, etc.), time, date, routing information, Internet Protocol (IP) address information, and other metadata may be included in metadata field 216.

Data file 214 may also include at least one passthrough field 219, that includes passthrough information from client drafted inquiry 202. In examples, passthrough field 219 of data file 214 includes data of a non-converted format (e.g., original email, video, image, voice files, and/or the like). Information in one or more passthrough fields may are viewable downstream (e.g., by an agent, manager, client, and/or the like) for reference purposes. In examples, information passthrough field 219 may not be formatted such that information therein is understandable by intelligent delegation system 220, and/or an API thereof, and may not be usable by computer program code 230 and/or by agent selection test 242 due to data formatting incompatibility. Data file 214, may include additional fields, not shown, when determined useful for inquiry resolution, delegation, and/or machine training of intelligent delegation system 220.

Intelligent delegation system 220 includes at least one processor 222, which may be locally situated and/or remotely distributed. Processor 222 communicates with at least one local and/or remote memory area 228, which at least stores computer program code 230 that when executed causes processor 222 to perform operations. Intelligent delegation system 220 also include user interface component 224 and network interface component 226, both of which receive and send input and output.

Computer program code 230, upon execution, causes processor 222 to receive various information from a variety of sources and convert the received information into an electronic case file 244A. Natural language parser 232 receives natural language data from natural language field 218 and performs word recognition using word recognition component on text parsed from the natural language field 218. In examples, an entity recognition component parses the words and phrases natural language field 218 to recognize and identify individual entities. An entity is a component of the natural language field 218 which the system ascertains to be distinct from other components of natural language field 218. For example, pronouns such as “a”, “an”, or “the” are often not distinct in the context of a query, but a noun such as “credit card”, “keypad” or “rewards points” may have distinct relevancy. In examples, a relationship extractor component analyzes the parsed data to determine relationships between the recognized entities, extracting those identified relationships between the entities. In some examples, the identified relationships may be causal relationships or correlation relationships between the entities, linked by a clue word or phrase that forms a dependency between the entities within the parsed subject matter. In examples, a ranking component uses the identified entities from an entity recognition component and the extracted relationships from a relationship extractor component and ranks the data identified to generate results. Any number of methods may perform entity recognition. For example, simple sentence parsers or shallow parsing/dependency parsing techniques may parse the sentence searching for nouns, adverbs, verbs, or other sentence components. These parsers may also identify punctuation or other elements of sentence structure which may aid in entity recognition. Upon parsing the sentence, entity recognition component may return a list of entities. Additionally, domain dictionaries or other sources of definitions may be used to aid entity recognition component in parsing the information or to enable the system to learn how to recognize entities.

The process extracts one or more relationships identified between the recognized entities using a relationship extractor. Relationship extraction is performed on the entities recognized by entity recognition component in addition to any relevant phrases or words that are related to the identified entities. However, relationship extraction may also be performed independent of entity recognition and may be based on other criteria. Relationship extraction may be performed by any number of methods. Methods of relationship extraction have been found to have different success rates depending on the context and searches performed. Some such methods involve causal analyses, which analyze a cause and effect relationship, and/or correlation analyses, which analyze how different entities may be related.

With entities, such as words and phrases, and extracted relationships therebetween, natural language parser 232 identifies a number of possible issues that the natural language may be attempting to describe. Data points may be assigned to each of the possible issues identified by natural language parser 232, each of which may be compared to data points assigned to previously identified issues stored in a historical data repository 272. Based on probability scores, threshold scores, and/or modeling, natural language parser 232 may identify one or more issues described by the natural language of the client drafted data inquiry.

With respect to modeling, natural language parser 232 may identify the best fit curve by running a number of models against normalized words and phrases, and extracted relationships therebetween, using a number of data points from the normalized data and a R² value (statistical measure of curve fitness) to determine which model is the best fit for providing the issue identification selection. For example, a linear model may have a minimum threshold of three data points, a log linear model may have a minimum threshold of four data points, a power model may have a minimum threshold of five data points, and a logit model may have a minimum threshold of five data points. Natural language parser 232 may determine which of the possible issues are identified by the client drafted inquiry based on fitting data points of the potential issues and the previously identified issues stored in a historical data repository 272 to one or more best fitting model. In short, natural language parser 232 identifies one or more issues described by the client drafted inquiry 202 using at least the natural language field 218 of data file 214.

Parameter module 234 receives the one or more identified issues from natural language parser and metadata data from the metadata field 216 of data file 214 and identifies parameters associated with the identified issues. Parameters may be related to information about the client, the client drafted inquiry, and/or one or more identified issues of the inquiry. Parameters influence and/or determine which agents are more likely to effectively resolve identified issues and which agents may be incapable or inappropriate selections for one or more clients, inquires, and/or identified issues. In short, using parameters improve intelligent delegation system's delegation functionality by increasing the amount of information used in the delegation function and increasing the quality of information used in the delegation functions performed by the delegation system. Parameters may be apparent from the natural language of the client drafted inquiry, may be determined from metadata of the client drafted inquiry, and may be derived from a combination of natural language and metadata of the client drafted inquiry. Some parameters may be further derived from other determined/derived parameters.

Example parameters associated with the client, inquiry, and/or issues identified from the inquiry include, but are not limited to, client ID, client name, a client's priority level (e.g., standard client, gold level client, platinum level client, and the like, which may be based on a volume of transactions, a service fee, number of point of sales, and/or the like), a client's industry, language or languages of the inquiry, an identified disruption type, an identified disruption level, a program type, a client's program enrollments, a program's rules, service type, a client's service enrollment, service rules, related services and/or programs, a client's non-enrolled services and/or programs, a client's operating hours (including time zone information), regulatory agencies related to the client and/or an identified issue, and many more. Parameters associated with inquires and issues may be stored, linked, and tracked in historical data repository 272, and parameters associated with clients and inquires may be stored, linked, and tracked in client data repository 264. One or more data repositories disclosed herein may be separated, combined, and/or distributed as is desired for processing speed, costs, security, and/or the like.

Context module 236 receives one or more identified issues from natural language parser 232 and metadata data from the metadata field 216 of data file 214. Context may be related to information about the client, the client drafted inquiry, and/or one or more identified issues of the inquiry. Context is used to influence and determine which agents are more likely to effectively resolve identified issues and which agents may be incapable or inappropriate selections for one or more clients, inquires, and/or identified issues. In short, using context improves intelligent delegation system's delegation functionality by increasing the amount of information used in the delegation function and increasing the quality of information used in the delegation functions performed by the delegation system. Context may be apparent from the natural language of the client drafted inquiry, may be determined from metadata of the client drafted inquiry, and may be derived from a combination of natural language and metadata of the client drafted inquiry. One or more context may be further determined/derived from other determined/derived context.

Example of context include, but are not limited to, client ID, account rules associated with the client, regions that the inquiry or issues involves or affects, priority levels, a client's preferences (e.g., in-person vs. telephone vs. email help, the time of day for help, a single contact point vs. agents of various expertise, male vs. female assistance, a person's accent, etc.), prevalence of issues (e.g., frequency of a same issue, frequency of any issues, complexity of repeat issues, etc.), previous related inquires and/or issues (e.g., slow bandwidth speeds may be related to timeout errors and/or poor battery life), previously accepted solutions (e.g., coupons, replacing hardware, paying extra for upgrades, discounts for disruptions, apology letters for mistakes, free upgrades for disruptions, etc.), previous agents producing client satisfaction and/or dissatisfaction (e.g., an agent the client connected with or matched with their approach or personality type, an agent with a sense of humor the client found offensive, and/or the like), natural language's tone (e.g., happy, frustrated, angry, inquisitive, impulsive, solution seeking, annoyed, kind, etc.), sophistication level (e.g., technical sophistication, business savvy, worldly experience, well-read, and/or the like), inquiry and/or issue complexity (e.g., single resolvable issue, issues involving heavy government agency regulation, multiple issues intertwined and causing each other's disruptions, issues causing data loss or financial loss, which may be rated via a scale such as low, medium, high, a numerical scale, and the like). Context associated with inquires and issues may be stored, linked, and tracked in historical data repository 272, and context associated with clients and inquires may be stored, linked, and tracked in client data repository 264. One or more data repositories disclosed herein may be separated, combined, and/or distributed, as is desired.

Agent qualifications module 238 receives some or all of the one or more identified issues from natural language parser 232, data from the metadata field 216 of data file 214, related parameters from parameter module 234, and related context from context module 236. The received information is analyzed by agent qualifications module 238 to influence and determine which agent qualifications are more likely to effectively resolve identified issues given the identified parameters and context, and which agent qualifications may be insufficient or inappropriate given the identified parameters and context, inquires, and/or identified issues. Analyzing agent qualifications when delegating issues improves the intelligent delegation system's delegation functionality by increasing the amount of information used in the delegation function and increasing the quality of information used in the delegation functions performed by the delegation system. Qualifications may be related to information about individual agents, agent teams, and their respective skills. Agent qualifications may be stored in one or more agent qualification data repositories 266 that are accessible by intelligent delegation system 220 and dynamically updateable by one or more agent systems 270A-270N.

Examples of stored, linked, and tracked agent qualifications include, but are not limited to, agent ID, last name, first name, team, group, languages spoken and/or written, skills, experience, certifications, degrees, training, personal interests (e.g., gaming, horseback riding, gardening, social media, sports, retail shopping, etc., which may cause an agent to have unique personal knowledge about a client's industries), resolution success score and attitude score (wherein scores may be indicative of a type of attitude or a sliding scale from a negative and/or ornery attitude to a positive and/or cooperative attitude, percentage based, threshold based, and/or a comparative score with regard to other agents), personality type, which may be adjective based (e.g., cheery, professional, chatty, and the like) and/or based on a personality test (e.g., enneagram type, Myers Brigg testing, and the like), recorded achievement, employee position (e.g., manager, trainer, trainee, etc.) and/or employee level.

A specific agent qualification may be an asset or detriment to the resolution of a specific issue contingent on the particularly identified issues from an inquiry as well as the associated context and parameters of each issue, client, and/or inquiry. For example, an intelligent delegation system 306, which identifies a hardware installation issue is being experienced by a client determined to be a doctor, of minimal technological sophistication, exceptional formal educational sophistication, and historically high satisfaction ratings when paired with cheery yet succinct highly educated women agents having personal interests in sports, health, and wellness, may intelligently select a highly compatible agent by executing a test based at least on agent quantifiable qualifications and agent quantifiable conditions such that an qualified agent have compatible personality traits who is presently experiencing advantageous work conditions may provide a satisfying resolution for the client.

In contrast, traditional agent assigning systems, which match clients on far less consideration, if any at all, typically fail to evaluate context and/or parameters a client's issues, client's proclivities, and/or specific inquiries. Further, traditional agent assigning systems do not executing tests considering one agent's quantifiable qualifications over another or one agent's quantifiable conditions over another. Accordingly, traditional agent assigning systems are incapable of matching qualified agents have compatible personality traits that are presently experiencing advantageous work conditions that may increase the probability of providing a satisfying resolution for a particular client having a particular issue.

In an example, referring back to the above example involving the doctor experiencing a hardware issue, traditional agent assigning systems would be unaware the client is a doctor who has minimal technological sophistication, exceptional formal educational sophistication, and works well with cheery yet succinct highly educated women interested in sports, health, and wellness. As a result, a conventional agent assignment system (e.g., relying on a round robin assignment technique, a first in first out (FIFO) queuing assignment technique, and/or the like) may assign an agent from a hardware installation department to resolve the doctor's issues; however, due to the traditional system's inability to consider further relevant information such as client/issue context, client/issue parameters, agent qualifications, and agent conditions, the assigned agent may start at a significant disadvantage through no fault of his own by happening to be a male agent with a chatty nature, sarcastic sense of humor, limited formal educational, and a disinterest in sports, health, and wellness. Because conventional agent assignments are not configured to determine, create, and/or execute tests based on such information, the assigned the male agent may be unlikely and/or incapable of achieving client satisfaction, even if the identified issue is resolved, which reduces customer satisfaction, reduces employee satisfaction, reduces customer loyalty, and increases employee turnover. Simply put, functionalities enabled by modifying conventional agent assignment systems and methods to include intelligent delegation system 220, which among other unique functional improvements, intelligently pairs clients with a highly compatible agents by creating and executing tests based at least on agent quantifiable qualifications and agent quantifiable conditions to ensure an assigned agent is sufficiently qualified while also sharing compatible personality traits and advantageous work conditions thereby significantly increasing the probability of a satisfying resolution for the client and an enjoyable working environment for the agent.

Agent qualifications module 238 sends the results agent selection test 242, which improves traditional delegation methods by intelligently evaluating the identified issues and their associated context and parameters and dynamically assigning quantifiable values (e.g., scores) to agent qualifications based on the parameters and context associated with the identified issues of a particular client drafted inquiry. Some quantifiable values may be weighted if desired, for example, training or skills determined to be important to resolution of an issue may be weighted more heavily than personal interests, personality type, and/or attitude scores. In another example, if context determines that the client of the client inquiry placed high value on one or more client preference and/or the inquiry tone is particularly acute, then agent qualifications module 238 may weight qualifications related to the highly valued client preferences, employee position (e.g., manager, high level manager, etc.), and/or resolution success score.

Agent conditions module 240 receives some or all of the one or more identified issues from natural language parser 232, data from the metadata field 216 of data file 214, related parameters from parameter module 234, and related context from context module 236. The received information is analyzed by agent conditions module 240 to influence and determine which agent conditions are more likely to effectively resolve identified issues given the identified parameters and context, and which agent conditions may be insufficient or inappropriate given the identified parameters and context, inquires, and/or identified issues. Analyzing agent conditions when delegating issues improves the intelligent delegation system's delegation functionality by increasing the amount of information used in the delegation function and increasing the quality of information used in the delegation functions performed by the delegation system. Conditions may be related to information about individual agents, agent teams, and their respective skills. Agent conditions may be stored in one or more agent condition data repositories 268 that are accessible by intelligent delegation system 220 and dynamically updateable by one or more agent systems 270A-270N.

Examples of stored, linked, and tracked agent conditions, including, but not limited to, agent ID, preferences (e.g., preferences for hardware issues over software issues) citizenship (e.g., due to agency rules and regulations some agencies require certain citizenship to handle certain issues), clearance level (e.g., top secret, high admin credentials), work hours (e.g., daily schedule including time zone information), out-of-office indications (e.g., status indications of being in a meeting, at lunch, on vacation, upcoming schedule vacations, medical leave, and the like), overtime tracker (e.g., tracking current and predicted overtime should additional issue be assigned to an agent), location (e.g., working from home, city, state, regions, country, and the like which may affect regulatory rules, confidential information, and national security), currently available workload bandwidth and current workload quantity (e.g., to help balance the workload of similarly qualified agents), current workload complexity (e.g., to prevent agent burn out and explain skewed load balance statistics), current workload majority type (e.g., to leverage information recently learned by an agent and/or ensure work type diversity to avoid burn out), employer (e.g., first party in-house employer and/or outsourced third-party employer), and/or conflicts of interest (e.g., an agent with confidential knowledge about one client may be walled off from a competitor).

A specific agent condition may be an asset or detriment to the resolution of a specific issue contingent on the particularly identified issues from an inquiry as well as the associated context and parameters of each issue, client, and/or inquiry. A financial institution experiencing data loss issues in Mexico may be regulated by Mexico's Department of Ministry's Fintech rules. In such an example, agent selection may be limited to a Mexican citizen employed by the in-house first-person employer and officed within Mexico. While another agent in America may currently have significantly more available workload bandwidth, the American agent located in New York City may not qualify under Fintech rules to manage the issue of the client drafted inquiry.

Agent conditions module 240 sends the results agent selection test 242, which improves traditional delegation methods by intelligently evaluating the identified issues and their associated context and parameters and dynamically assigning quantifiable values (e.g., scores) to agent conditions based on the parameters and context associated with the identified issues of a particular client drafted inquiry. Some quantifiable values may be weighted if desired, for example, regulatory rules determined to be important to compliance with agency standards and/or conflicts of interest scores may be weighted more heavily than overtime tracker scores and/or bandwidth availability. In another example, if context determines that the inquiry tone is particularly acute, then agent qualifications module 238 may heavily weight conditions related currently available workload bandwidth and/or current workload complexity, given that regulatory rules and clearance level considerations are not violated.

Intelligent delegation system 220 receives information from a variety of sources and improves the functionality of conventional agent selection system by adding the flexibility to execute a modifiable agent selection test 242 which adjusts quantifiable values (e.g., scores) to agent qualifications and conditions based on the parameters and context associated with the identified issues of a particular client drafted inquiry. Further, greater flexibility is realized by adding functionality that adjusts weights of values considered by the test to provide personalized service that satisfies the idiosyncrasies of individual clients. Using the scored agent qualifications and scored agent conditions, as weighted based on the determined context and parameters, agent selection test 242 selects one or more agents for assignment of the issue. When agent selection test 242 identifies more than one agent suitable to resolve the issue, agent selection test 242 may rerun the test on the subset of agents selected by the first test run and adjust the weights of current workload availability, current workload complexity, and current workload type, for example, in order to narrow the identified agents to further narrow the selection results.

A selected unit of agent selection test 242 may be an individual agent selected to resolve an issues, an agent group, an agent team, an agent region, a third-party agent individual, group, and/or team, and/or the like, wherein agent groups, teams, and regions have been identified as including multiple agents having a threshold amount of the same qualifications.

Intelligent delegation system 220 creates electronic case file 244A, which at least includes a data file field 246, which includes some or all of the information from data file 214, identified issue field 248, which includes at least one issue identified by natural language parser 232, and agent selection field 250, which includes an identification of agent (or agent unit) selected agent selection test 242.

Intelligent delegation system 220 sends electronic case files 244N to case management system 204, which reads the agent selection field 250, maps the indicated agent unit against a mapping of agents stored in memory 208 to determine which agent system of a plurality of agent systems (270A-207N) is associated with the agent unit indicated in the agent selection field 250. With the agent system identified, case management system 204 sends the electronic case file to the agent system associated with the selected agent unit.

Intelligent delegation system 220 also includes computer training code 254 that receives historical data files 256 and historical electronic case files 258. The historical information may be received from historical data repository 272. Intelligent delegation system 220 also receives feedback information 274, which includes among other information, resolution ratings 260 that rate the success and/or failure of issue resolution, issue identification, parameter determinations, context determinations, agent conditions determinations, agent qualification determinations, and agent selection determinations. Computer training code 254 converts received historical data files 256, historical electronic case files 258, and resolution ratings 260 into training data 262.

Computer program code modifier uses training data 262 to modify portions of computer program code 230 to train intelligent delegation system 220 based on the newly evaluated information. Upon modification of computer program code 230, data file 214 received after the computer code modification may be managed differently and more effectively due to the new machine training.

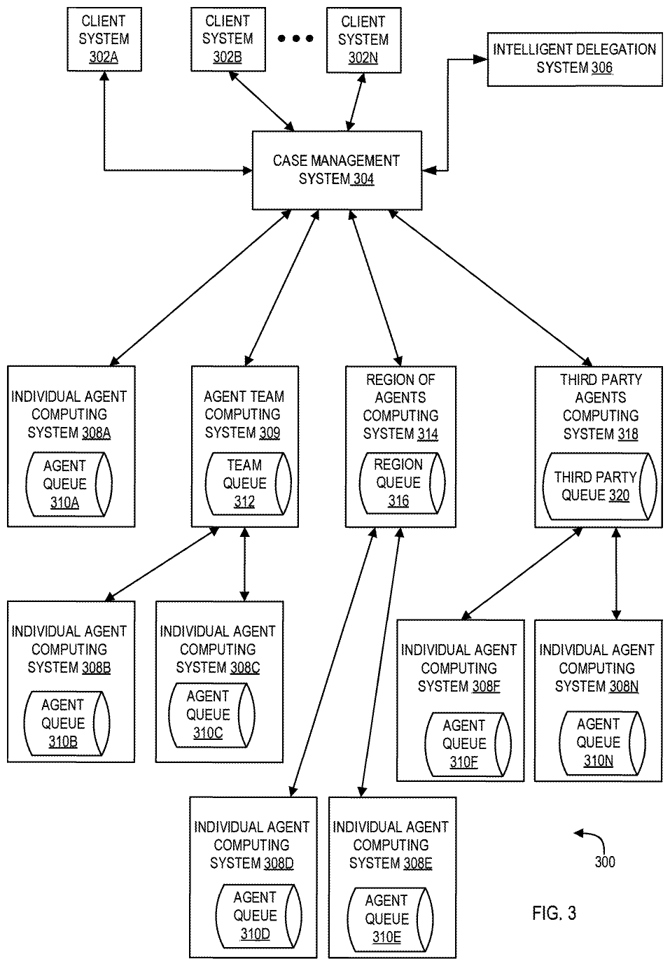

FIG. 3 is a block diagram illustrating a system configured for intelligently controlling resolution seeking inquiries according to an example. System 300 illustrates an architecture of an example system. Client systems 302A-302N generate and send client drafted inquires to case management system 304. Case management system 304 converts information from received client drafted inquiries into data files and sends the data files to intelligent delegation system 306. Intelligent delegation system 306 receives various additional information from various repositories and uses the received information and the data files to select an agent unit and create an electronic case file that indicates the selected agent unit. The electronic case file is sent to the case management system 304 which identifies the indicated agent unit and maps it against a table the maps agent units to their respective agent systems.

Case management system 304 may communicate with a plurality of agent systems including an example individual agent computer system 308A, an example agent team computing system 309, a region of agents computing system 314, which may be a compilation of system within a region or zone, an example third-party computing system 318, and more. Case management system 304 sends the electronic case file to a system determined to be associated with the agent unit indicated in the agent selection field of the electronic case file.

In an example, when the agent selection field indicates an individual agent, case management system 304 may send the electronic case file to the identified individual agent computing system 308A. Upon receiving the electronic case file, the computing system analyzes the electronic case file to determine a priority associated with the electronic case file. In examples, an indicator may indicate that an issue is critical, an issue is time prioritized, a client is level prioritized, and/or the like. If no criticality or priority indicator is included within the electronic case file, then the electronic case file is input to agent queue 310A as a FIFO electronic case file. If a criticality or priority indicator is included within the electronic case file, then the electronic case file is placed within agent queue 310A at the front of the queue, at a front portion of the queue, and/or at a location as indicated by the criticality or priority indicator as compared to other electronic case files having a criticality or priority indicator. If two or more electronic case files have the same criticality or priority indicator, then the conflict between the electronic case files is resolved using FIFO.

In other examples, when the agent selection field indicates an agent team, case management system 304 may send the electronic case file to the identified agent team computing system 310. An agent team may be organized by type of issues managed, type of services and/or programs managed, language, corporate entity designation, location, region, clearance levels, and/or any other organizational schema. Agent team members may be located within proximity of each other (in a same city and/or building) and/or geographically distributed. Upon receiving the electronic case file, the computing system analyzes the electronic case file to determine a priority associated with the electronic case file. If no criticality or priority indicator is included within the electronic case file, then the electronic case file is input to team queue 312 as is discussed above. If a criticality or priority indicator is included within the electronic case file, then the electronic case file is placed within team queue 312 as is discussed above. Electronic case files of the team queue 312 may be pushed and/or requested by individual agents of the agent team. Upon exiting team queue 312, an electronic case file is received by one of the individual agent computing systems (308B, 308C) of the team. The individual agent computing system (e.g., 308B or 308C) receives the electronic case file and/orders the electronic case file within its respective queue (310B or 310C) as is described above.

In other examples, when the agent selection field indicates a region of agents, case management system 304 may send the electronic case file to the identified region of agents computing system 314. A region of agents may be organized by a region of determined significance, for example, neighborhood, city, county, state, circuit, country, union of countries (e.g., European Union), continent, and/or the like. Various regions may be governed by agencies, governments, and/or associations having diverse rules, regulations, and compliance standards applicable to their respective defined region. An example region of agents may be organized in compliance with such rules, regulations, and compliance standards, for example, to improve the knowledge and skills of the agents therein, to comply with rules aimed at preventing distribution of information outside a region's boundaries, and/or the like. For example, in France, to avoid the loss of attorney-client privilege that may be attached to certain information, the information may not electronically exit a defined region of France. In another example, national security regulations of some regions forbid information of national security from electronically exiting the boundaries of regions. Further, in some examples, system 300 may be structured such that some or all of the systems handling data that is restricted by a region are located within the boundaries of the restricting region (e.g., regionalized client systems, a regionalized case management system, a regionalized intelligent delegation system, a regionalized region of agents computing system, and individual agent computing systems thereof).

Agents of a region of agents may be located within proximity of each other (in a same city and/or building) and/or geographically distributed within the defined boundary of significance. Upon receiving the electronic case file, the regions of agents computing system analyzes the electronic case file to determine a priority associated with the electronic case file. If no criticality or priority indicator is included within the electronic case file, then the electronic case file is input to region queue 316 as is discussed above. If a criticality or priority indicator is included within the electronic case file, then the electronic case file is placed within agent queue 316 as is discussed above. Electronic case files of the agent queue 316 may be pushed and/or requested by individual agents of the regions of agents. Upon exiting agent queue 316, an electronic case file is received by one of the individual agent computing systems (308D, 308E) of the region. The individual agent computing system (308D or 308E) receives the electronic case file and/orders the electronic case file within its respective queue (310D or 310E) as is described above.

In other examples, when the agent selection field indicates a third-party agent or third-party agent team, case management system 304 may send the electronic case file to the identified third-party agents computing system 318. A third-party agent or third-party agent team may be organized by type of issues handled, type of services and/or programs handled, language, corporate entity designation, location, region, clearance levels, and/or any other organizational schema. Third-party agent team members may be located within proximity of each other (in a same city and/or building) and/or geographically distributed. Upon receiving the electronic case file, the computing system analyzes the electronic case file to determine a priority associated with the electronic case file. If no criticality or priority indicator is included within the electronic case file, then the electronic case file is input to third-party queue 320 as is discussed above. If a criticality or priority indicator is included within the electronic case file, then the electronic case file is placed within third-party queue 320 as is discussed above. Electronic case files of the third-party queue 320 may be pushed and/or requested by individual third-party agents of the third-party agent team. Upon exiting third-party queue 320, an electronic case file is received by one of the individual agent computing systems (308B, 308C) of the team. The individual agent computing system (e.g., 308F or 308N) receives the electronic case file and/orders the electronic case file within its respective queue (310F or 310N) as is described above.

Third-party agents may be included within the overall system as an outsourcing technique that manages appropriate issues. However, some issues may be better handled or mandated to be handled internally, in which case, the agent selection test 242 would ensure issues that are better handled or mandated for internal handling are assigned to internal agents.

Once an electronic case file reaches the last position of an agent queue 310A-310N, the agent of the individual agent computing system 308A-308N opens the electronic case file and takes steps to resolve the issues identified therein. The electronic case file may include the determined parameters and context associated with the identified issues, and the agent may use the determined parameters and context to better service the client. For example, a client's preferences, identified industry, previously accepted solutions may provide clues to the agent as to strategies which may bring forth a satisfactory resolution for the client.

Upon resolution of the issues of an electronic case file, the agent may provide feedback within fields of the electronic case file or a file that is associated with the electronic case file. The feedback may include resolution results of the issues of the electronic case file, ratings or other quantitative scores of the accuracy of the parameters, context, agent conditions, agent qualifications used by the agent selection test as well as the any aspects of the agent selection test itself. Some or all of the feedback may be sent to the case management system which sends some or all of the feedback to the intelligent delegation system for use by computer training code (254 of FIG. 2) and computer program code modifier (252 of FIG. 2). Some or all of the feedback may be sent to agent condition data repository (268 of FIG. 2), agent qualifications data repository (266 of FIG. 2), and/or client data repository (264 of FIG. 2) to update the information thereof. Some or all the feedback may be sent to historical data repository (272 of FIG. 2) to update the information therein and/or archiving the electronic case file and the feedback thereof.

FIG. 4 is a diagram illustrating data conversion examples of a system configured for intelligently controlling resolution seeking inquiries according to an example. Example 400 illustrates an example client drafted inquiry 401 received as an email by case management system (204 of FIG. 2). The text format of the email of client drafted inquiry 401 may be HTML, plain text, rich text, and/or the like. The email of client drafted inquiry 401 may include attachments of any format. For example, document 422A is attached to the email and may be formatted according to PDF, JPEG, DOC, XLSX, VSD, QDF, and/or any other format. In another example, video 422B is attached to the email and may be formatted according to GIF, AIFF, WAV, and/or any other format. Further, audio 422N is attached to the email and may be formatted according to m4a, AVI, and/or any other format.

Case management system (204 of FIG. 2) receives client drafted inquiry 401 as an email and extracts information from the email of client drafted inquiry 401 and converts the extracted information for inclusion within fields of data file 402. In examples, case management system (204 of FIG. 2) extracts information from attachments of the email and converts the extracted information for inclusion within fields of data file 402.

Data file 402 includes a metadata field 403, which includes a metacontent field 405 that includes a variety of metadata types, for example, descriptive metadata 406 (e.g., used for discovery and identification and may include elements such as title, abstract, author, keywords, and the like), structural metadata 407 (e.g., describing containers of data and indicating how compound objects are organized such as, pages being ordered to form chapters, types, versions, relationships and other characteristics of digital material), reference metadata 408 (information about the contents and quality of statistical data), administrative metadata 409 (e.g., information helping to manage a resource, like resource type, permissions, IP rights, and when and how it was created), and process metadata 410 (e.g., describe processes that collect, process, or produce data).

Metadata field 403 may also include a metacontext (syntax) field 411 that includes a variety of syntax types (e.g., markup language) that are compatible with a variety of data formats (e.g., text, images, audio, video, multimedia, and the like). More than one syntax type may be included within data file 402 depending on the content and attachments of the client drafted inquiry. Metacontext (syntax) field 411 may include a plurality of fields but not limited to, XML, HTML, Plain Text, RDF, AIIF, XMP, WAV, Exif, MP4, MPC, and/or the like.

Data file 402 also includes a natural language field 427 including natural language extracted from the email of client drafted inquiry 401 and extracted from any attachment thereto (e.g., videos, images, voice files, multimedia files, and the like). Example natural language field 407 includes a body of the email field 412, subject line field 413, signature line field 414, and at least one natural language of attachments field 416. In examples, natural language extracted from different attachments may be included in different fields.

In examples, data file 402 may include one or more passthrough fields 404A-404Z, that includes passthrough information from client data inquiry 401, in a non-converted format (e.g., original email, video, image, voice files, and/or the like). Information in one or more passthrough fields may be viewed downstream by an agent for reference purposes. In examples, information in a passthrough field may not be formatted such that information therein is understandable by the intelligent delegation system 220 and may not be used by computer program code 230 and/or by agent selection test 242 due to the data formatting incompatibility.

In examples, passthrough field 404A includes a copy of the email of client drafted inquiry 401. Pass though field 404B includes a copy of document 442A, which was attached to the email. Passthrough field 404C includes a copy of video 422B, which was attached to the email. Passthrough field 404N includes a copy of audio (e.g., music) 422N, which was attached to the email. Additional fields, not shown, may be included within data file 214.

Intelligent delegation system 220 receives data file 402 and natural language parser 232, extracts natural language data from natural language field 427, and performs word recognition using word recognition component on natural language parsed natural language fields (e.g., 412, 413, 414, 416, and the like). Based at least on the parsed natural language information, natural language parser 232 identifies one or more issues described by the natural language of the client drafted inquiry 401.

Received data file 402 also includes metadata field 407, and parameter module 234 extracts information from metadata field 407 and receives the one or more issues identified by natural language parser 232. Responsive to the extracted metadata and received one or more identified issues, parameter module 234 determines parameters that correspond to the one or more identified issues. Example parameters object file 420 is an example object file created by parameter module 234, which may be used by agent selection test 242 during agent selection and portions of which may be included within electronic case file 244A.

Parameters object file 420 includes data fields that parameter module 234 determined to be relevant to an identified issue. Client ID field 404A indicates an alias identity of the client. Client ID field 404A may be populated by parameter module 234 using information from natural language field 427 and/or metadata fields 403 mapping that information to data received from client data repository 264 to determine an alias ID for the client that drafted the client drafted inquiry 401. Parameter module 234 may use similar techniques to populate the client name field 404B.

Parameter module 234 may use information from populated fields of the parameters object file 420 as well as natural language parser 232, historical data repository 272, and/or client data repository 264 to determine information to populate some of the fields of parameters object file 420. For example, information from client ID field 404A may be used along with information from client data repository 264 to determine the client's operating hours to populate the operating hours field 404Q, the client's industry to populate the industry field 404D, and regulatory agencies related to the client to populate related regulatory agencies field 404N. Further, information from natural language parser 232 coupled with information in client data repository 264 may be sufficient to identify which programs and/or services the client is currently enrolled (for populating fields 4041 and 404L), and the information populating fields 4041 and 404 may help determine which program type and/or service program type is at issue in the client drafted inquiry 401 for population of program type field 404H and service type field 404K.

In examples, natural language parser 232 populate language field 404E based on insights thereof. Further, information from client data repository 264 may populate and/or supplement language field 404E. Some fields of parameters object file 420 may not be applicable and could populate with a null value and/or be eliminated from an individual parameters object file 420.

With respect to program rules and service rules associated with a client and/or identified issues, due to the potential number of applicable rules and the relevant tests which certify compliance therewith, program rules field 404J and service rules field 404L may be populated with an executable function, object code and/or a link to the applicable information. For example, program rules field 404J may be populated with an executable function that when passed downstream to an agent resolving the issue, allows the agent to provide input to the executable function and receive a result indicating whether program rules are violated and/or satisfied. In another example, service rules field 404L may be populated with object code that when passed downstream to an agent resolving the issue, is extracted by the agent's computing system 308B and used while resolving an issue of the inquiry. In yet another example, field 404J and/or 404L may be populated with a link (e.g., hyperlink, pointer, and/or the like) to a document and/or list (e.g., stored in a data repository), so that when passed downstream to an agent resolving the issue, selection of the link makes the document and/or list accessible to the agent for guidance.

With respect to related services and programs of the client and/or non-enrolled services and programs of the client, due to the number of potentially applicable services and roles, which may be offered by an agent during issue resolution, as a solution and/or upgrade, as well as the amount of content involved with explaining each non-enrolled services and programs of the client, non-enrolled services/programs field 404P may be populated with a link that launches an application indicating the non-enrolled services and programs and content associated therewith.

With respect to disruption type field 404F and disruption level 404G, parameter module 234 may use information from natural language parser 232 and receive information from historical data repository 272 and/or client data repository 264 to determine the type of disruption and level of disruption, if any, the client is experiencing. In examples, parameter module 234 may determine a list of possible disruption types and levels, and instead of populating the fields with a single disruption type and level, parameter module 234 may populate disruption type field 404F and/or disruption level field 404G with respective links to an object (e.g., computer code module, list of disruption types and/or levels, etc.) that is stored in one or more memory for further analysis downstream that may name a specific disruption type and/or level or may narrow the disruption type and/or level list using information gathered by a different module (e.g., context module 236).

For instance, context module 236 executes a link of a field (e.g., disruption type field 404F), adds contextual information, determines a disruption type, and populates disruption type field 404F with a named disruption type. In instances, context module 236 determines multiple disruption types and populates disruption type field 404F with a plurality of named disruption types or a link to a plurality of named disruption types.

In instances, agent selection test 242 performs an agent assignment selection even when one or more context fields (e.g., disruption type field 404F) is populated with multiple determinations (e.g., more than one a plurality of named disruption types or a link to a plurality of named disruption types). In examples, agent selection test 242 may identify one or more agents and/or teams capable of resolving all the disruption types of the disruption type field 404F, and the one or more agents and/or teams may each be considered by agent selection test 242 when selecting an agent or team. Further, agent selection test 242 may identify one or more agents and/or teams capable of resolving a threshold amount of the disruption types of the disruption type field 404F, and the one or more agents and/or teams capable of resolving the threshold amount may each be considered by agent selection test 242 when selecting an agent or team. In further examples, agent selection test 242 may identify which of the disruption types of the disruption type field 404F are not manageable by the one or more agents and/or teams capable of resolving a threshold amount of the disruption types of the disruption type field 404F, and agent selection test 242 may separate those identified disruption types for assignment to one or more different agents or teams. Fields described herein are exemplary; additional fields of additional parameters and/or less field of less parameters may be used without departing from the description herein.

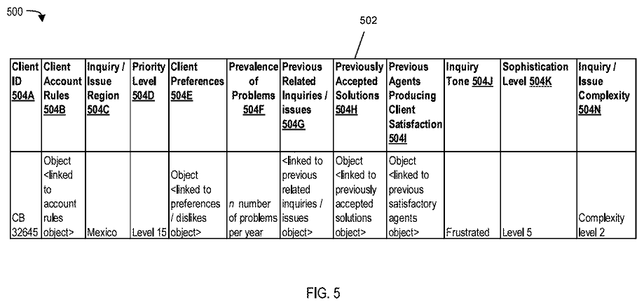

In some examples, parameter module 234 executes before, in parallel, and/or after execution of context module 236. As information is made available via execution of parameter module 234, that information is made available to context module 236, and as information is made available via execution of context module 236, that information is made available to parameter module 234. Regardless of the order of execution, parameter module 234 may use information made available by context module 236, upon its availability, when populating fields of parameters object file 420 and/or for other purposes. Likewise, regardless the order of execution, context module 236 may use information made available by parameter module 234, upon its availability, when populating fields of context object file (502 of FIG. 5) and/or for other purposes.

FIG. 5 is a diagram illustrating data conversion examples 500 of a system configured for intelligently controlling resolution seeking inquiries according to an example. In this example, context module 236 determines context corresponding to the one or more identified issues of client drafted inquiry (401 of FIG. 4), which case management system (204 of FIG. 2) converted into data file (402 of FIG. 4). In examples, context module 236 creates context object file 502, during or after performing context determination, wherein context object file 502 may be used by agent selection test 242 during agent selection and portions of which may be included within electronic case file 244A.

Context object file 502 includes data fields that context module 236 determined to be relevant to an identified issue. Client ID field 504A may indicate an alias identity of the client. Client ID field 504A may be populated by context module 236 using information from natural language field 427 and/or metadata fields 403 mapping that information to data received from client data repository 264 to determine an alias ID for the client that drafted the client drafted inquiry 401. In examples, client ID field 404A may be extracted from client ID field 404A of parameters object file 420 of FIG. 4.

Context module 236 may use information from populated fields of the context object file 502, as well as natural language parser 232, historical data repository 272, and/or client data repository 264 to determine information to populate some of the fields of context object file 502. For example, information from client ID field 404A may be used along with information from client data repository 264 to determine information for population of inquiry/regions region field 504C. In instances, priority level field 504D may indicate a level of importance associated with an electronic case file, and in examples, a priority level may be based on a quality of service level associated with a client, a type of service interruption associated with an identified issue (e.g., partial and/or full credit card reader hardware failure, communication latencies, data loss, and/or the like). Further, a prevalence of problems field 504 may be included, which, in examples, may be a numerical calculation of the number of previously received client data inquires and/or previously identified issues.

In examples, information from natural language parser 232 may assist in identify information to populate a tone in the inquiry tone field 504J, which indicates the tone of voice and/or present state of mind of the person who drafted the client drafted inquiry. In examples, inquiry tone field 504J may be populated with an adjective describing a mood of a person (e.g., happy, frustrated, scared, anxious, angry, and/or any other human mood or emotion). In examples, inquiry tone field may be supplemented and/or populated with a numerical value indicative of the drafting person's mood and/or emotional state. If desired, natural language parsed from data file 214 may be compared to historical data files drafted by the same person to determine a comparator regarding the drafting person's previous and/or typical mood as compared to the drafting person's current mood. Such a comparator improves the functionality of the intelligent delegation system by providing new and helpful information that can be used to more accurately select the appropriate agent to resolve identified issues producing quicker resolution turnaround and with increased client satisfaction.

Context module 236 may also populate sophistication level field 504K with an adjective and/or numerical level indicative of the client's level of sophistication. The sophistication level field 504K may be populated based on a determination of natural language parser 232 based on which words were included within the client drafted inquiry and/or sophistication indicators provided by any of the client, sales consultants, installation persons, and agents who resolved previous issues of the client, as well as calculatable indicators such as prevalence of problems, prevalence of repeated problems, and/or the like.

Context module 236 may also populate inquiry and/or issue complexity field 504N with an adjective and/or numerical level indicative of the complexity of the issue or issues. Various factors may be considered when rating issue complexity including, but not limited to, a number of interrelated issues, a number of regulatory agents involved, a number of rules governing the issues, a number of different agents involved in the resolution, repeated prevalence of the issues, type classification or lack thereof of the issues, a number of client locations affected by the issues, limited time periods within which issues may be diagnosed, a number of different clients affected by the issues, a number of region boundaries within which data is restricted, a number of different types of programs and/or services affected by the issues, cost amount attributed to liability associated with resolution failure, and/or the like.

Context module 236 may also populate fields that may include large amounts of information, for example, previous related inquires/issues field 504G, previously accepted solutions field 504H, and/or previous agents producing client satisfaction field 504I, with a link (and/or other pointer mechanism) to a document and/or list (e.g., stored in a data repository), so that when passed downstream to an agent resolving the issue, selection of the link makes the document and/or list accessible to the agent for guidance. In some example, one or more of the fields may be populated with a link that launches an application indicating related inquires/issues, previously accepted solutions, and/or previous agents producing client satisfaction and any content associated therewith. An agent's access to such information may better familiarize the agent with issues and solutions that satisfied the client in the past thereby enabling the present agent to create additional client satisfaction by mimicking previous satisfaction causing variables.

With respect to client account rules, due to the potential number of applicable rules and the relevant tests which certify compliance therewith, client account rules field 504B may be populated with an executable function, object code and/or a link to the applicable information. For example, a field with an executable function may be passed downstream to an agent resolving the issue, thereby allowing the agent to provide input to the executable function and receive a result indicating whether rules are violated and/or satisfied. In another example, client account rules field 504B may be populated with object code that when passed downstream to an agent resolving the issue, is extracted by the agent's computing system 308B and used while resolving an issue of the inquiry.

Some fields of context object file 502 may not be applicable and could be populated with a null value and/or eliminated from an individual context object file 502. Any of the aforementioned fields may be populated with words, numbers, null values, executable functions, object code and/or links to applicable information, lists, applications, websites, and/or the like, as is described above. If desired, example systems may selectively prevent and/or restrict populating one or more fields with executable functions, object code, and/or a links, e.g., based on where the field may be destined. For example, an electronic case file is restricted to a region, preventing, and/or removing executable functions, object code, and/or a links may protect information from inadvertently electronically breaching the regions boundaries. Further, when an electronic case file is assigned to certain agents (e.g., third-party agents) executable functions, object code, and/or links are removed from fields and in some cases replaced with alternative information. Fields described herein are exemplary; additional fields of additional context may be used without departing from the description herein.

In examples, one or more issues could be related to each other, and parameter module 234 and/or context module 236 of computer program code 230 may group related issues into issue groups. For example, determined parameters and context that correspond to one or more identified issues may be scored, ranked, or otherwise quantified. Computer program code 230 may determine that two or more issues have scores that are within a threshold amount of each other, and based on the determination, group the two or more issues into an issue group, which may then be included within a single electronic case file to be resolved as a group. Other examples of grouping related issues into issue groups are discussed further below.

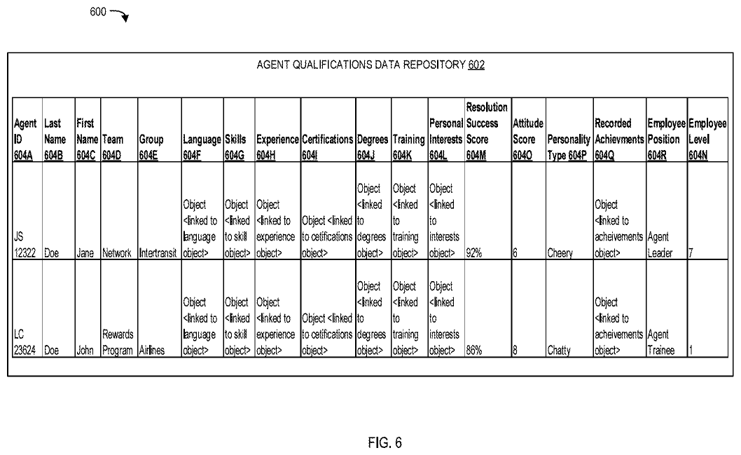

FIG. 6 is a diagram illustrating an example data repository scheme 600 configured for intelligently controlling resolution seeking inquiries according to an example. Agent qualification data describes qualifications of one or more agents in one or more tables, databases, relational databases, and/or the like. Agent qualification data repository 602 shows an example relational database with fields that store qualification or links to locations that store qualification information, executable functions, object code, applications, and/or websites related thereto (as described above). Data fields 604A-604N of agent qualification data repository 602 may be dynamically modified by one or more agent systems 270A-270N as new and updated information regarding agents, teams, and qualifications thereof changes in real time. Example information which may be included in one or more of data fields 604A-604N includes an agent ID alias, last name, first name, one or more team assignment, one or more group assignments, one or more languages spoken and/or written, identified skills, experience, certifications (e.g., technical certifications), degrees (e.g. educational degrees), training, personal interests, resolution success scores (e.g., which may be an overall score and/or parsed according to a category, e.g., service type, program type, issue complexity, industry, client tone, client sophistication level, etc.), attitude scores (e.g., which also may be an overall score and/or parsed according to any category mentioned above), personality type, recorded achievements, employee position, employee level, and/or any other qualification indicative of an agent's ability to understand an issue and/or personally connect to a client. Fields described herein are exemplary; additional fields of additional qualifications may be used without departing from the description herein.

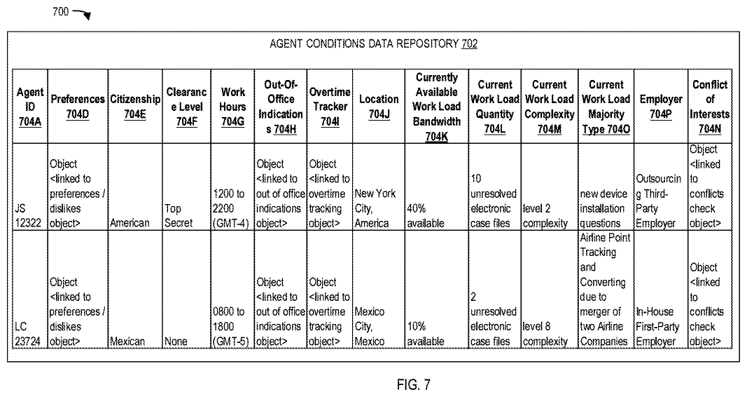

FIG. 7 is a diagram illustrating an example data repository scheme 700 configured for intelligently controlling resolution seeking inquiries according to an example. Agent condition data describes conditions of one or more agents in one or more of tables, databases, relational databases, and/or the like. Agent condition data repository 702 shows an example relational database with fields that store conditions or links to locations that store condition information, executable functions, object code, applications, and/or websites related thereto (as described above). Data fields 704A-704N of agent condition data repository 702 may be dynamically modified by one or more agent systems 270A-270N as new and updated information regarding agents, teams, and conditions thereof changes in real time. Example information which may be included in one or more of data fields 704A-704N includes, but is not limited to, agent ID alias information, preferences (e.g., preferred issue types, preferred clients and/or client types, preferred food, preferred hobbies, preferred social activities, and/or the like), citizenship, clearance level, work hours, out-of-office indications (e.g., such as an idle computer, in a meeting, scheduled future appointments, vacations, scheduled future vacations, medical leave, and the like), overtime tracker, location (e.g., home office, business office, city, state, regions, country, and the like), currently available workload bandwidth, current workload quantity, current workload complexity, current workload majority type, employer (e.g., internal, outsourced, third-party, etc.), conflict of interest, and/or any other condition indicative of an agent's availability and/or suitability to handle an issue and/or personally connect to a client. Fields described herein are exemplary; additional fields of additional conditions may be used without departing from the description herein.

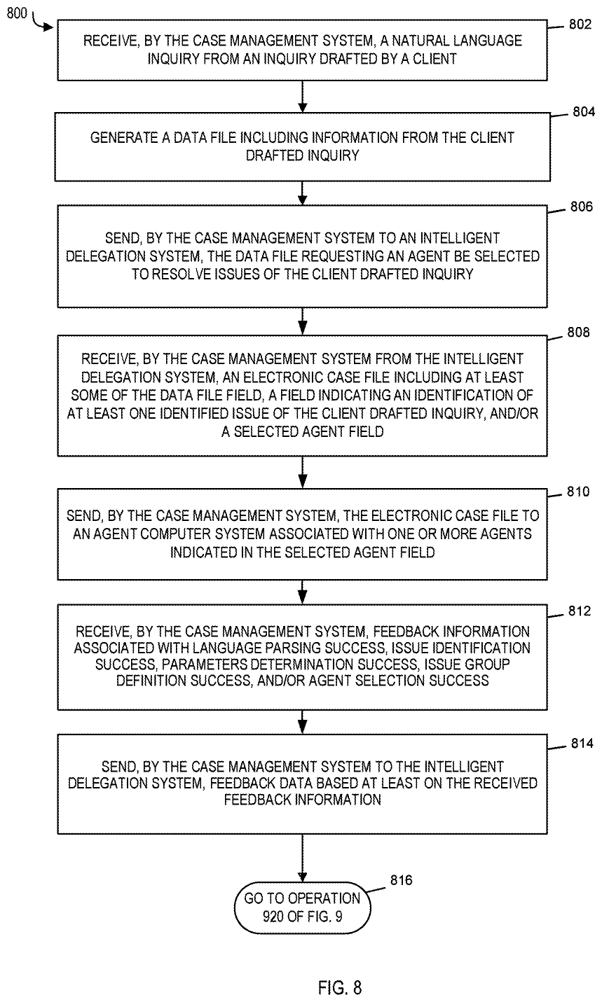

FIG. 8 is a flow chart illustrating a computerized method for intelligently controlling resolution seeking inquiries according to an example. In some examples, the method 800 may be performed or otherwise implemented on a system (e.g., systems 100, 200, 300, and 1100 of FIGS. 1, 2, 3, and 11, respectively) configured as described herein. At 802, one or more processors of the case management system receives a natural language inquiry drafted by a client. At 804, the case management system generates a data file including information from the client drafted inquiry. At 806, the case management system sends, to one or more processors of an intelligent delegation, the data file requesting an agent be selected to resolve issues of the client drafted inquiry.

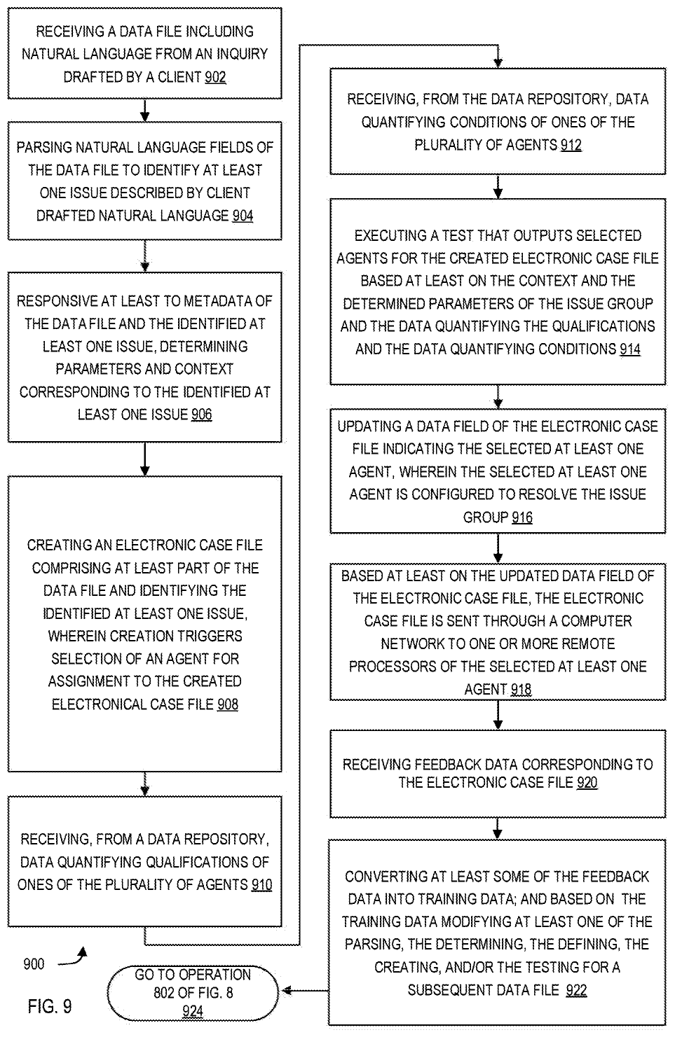

At 808, the case management system receives, from the intelligent delegation, an electronic case file including at least some of the data file field, a field indicating an identification of at least one identified issue of the client drafted inquiry, and a selected agent field. At 810, the case management system sends the electronic case file to one or more processors of an agent computer system that is associated with one or more agents indicated in the selected agent field. At 812, the case management system receives feedback information associated with language parsing success, issue identification success, parameters determination success, and/or agent selection success. At 814, the case management system sends feedback data to the intelligent delegation system, based at least on the received feedback information. At 816, method 800 moves to 920 of FIG. 9, which is discussed below.

FIG. 9 is a flow chart illustrating a computerized method for intelligently controlling resolution seeking inquiries according to an example. In some examples, the method 900 may be performed or otherwise implemented on a system (e.g., systems 100, 200, 300, and 1100 of FIGS. 1, 2, 3, and 11, respectively) configured as described herein. At 902, one or more processors receive a data file including natural language from an inquiry drafted by a client. At 904, the method parses natural language fields of the data file to identify at least one issue described by client drafted natural language. At 906, responsive at least to metadata of the data file and the identified at least one issue, the method 900 determines parameters and context corresponding to the identified at least one issue. At 908, the method creates an electronic case file comprising at least part of the data file and identifying the identified at least one issue, wherein creation of the electronic case file triggers the at least one processor to execute computer code that selects at least one agent of a plurality of agents for assignment to created electronic case file. At 910, method 900 receives, from one or more data repositories, data quantifying qualifications of one or more of the plurality of agents. At 912, the method receives, from the one or more data repositories, data quantifying conditions of one or more of the plurality of agents. At 914, the method executes a test that outputs selected ones of the plurality of agents for the created electronic case file based at least on the context and the determined parameters of the issue group and the data quantifying the qualifications and the data quantifying conditions. At 916, the method updates a data field of the electronic case file indicating the selected at least one agent, wherein the selected at least one agent is configured to resolve the issue group. At 918, based at least on the updated data field of the electronic case file, the electronic case file is routed through a computer network to one or more remote processors of the selected at least one agent. At 920, the method receives feedback data corresponding to the electronic case file. At 922, method 900 converts at least some of the feedback data into training data; and based on at least some of the training data, the method modifies at least one of the parsing, the determining, the defining, the creating, and the testing for a subsequent data file.

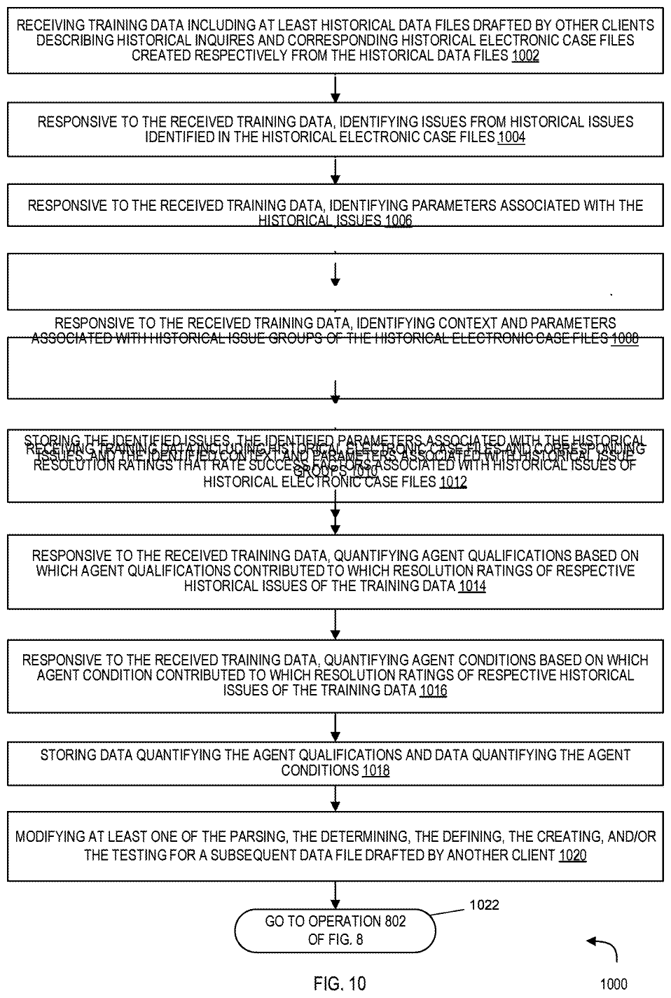

FIG. 10 is a flow chart illustrating a computerized method for intelligently controlling resolution seeking inquiries according to an example. In some examples, the method 1000 may be performed or otherwise implemented on a system (e.g., systems 100, 200, 300, and 1100 of FIGS. 1, 2, 3, and 11, respectively) configured as described herein. At 1002, method 1000 receives training data including at least historical data files drafted by other clients describing historical inquires and corresponding historical electronic case files created respectively from the historical data files. At 1004, responsive to the received training data, the method identifies a plurality of issues from historical issues identified in the historical electronic case files. At 1006, responsive to the received training data, method 1000 identifies parameters associated respectively with the historical issues. At 1008, responsive to the received training data, the method identifies context and parameters associated respectively with historical issue groups of the historical electronic case files. At 1010, method 1000 stores, in one or more data repositories, the identified plurality of issues, the identified parameters associated respectively with the historical issues, and the identified context and parameters associated respectively with historical issue groups. At 1012, the method receives training data including historical electronic case files and corresponding resolution ratings that rate success factors associated respectively with historical issues of respective historical electronic case files. At 1014, responsive to the received training data, method 1000 quantifies a plurality of agent qualifications based on which agent qualifications contributed to which resolution ratings of respective historical issues of the training data. At 1016, responsive to the received training data, the method quantifies a plurality of agent conditions based on which agent condition contributed to which resolution ratings of respective historical issues of the training data. At 1018, method 1000 stores, in one or more data repositories, data quantifying the plurality of agent qualifications and data quantifying the plurality of agent conditions. At 1020, the method modifies at least one of the parsing, the determining, the defining, the creating, and the testing for a subsequent data file drafted by another client. At 1022, method 1000 moves to 802 of FIG. 8, which is described above.

### Exemplary Operating Environment

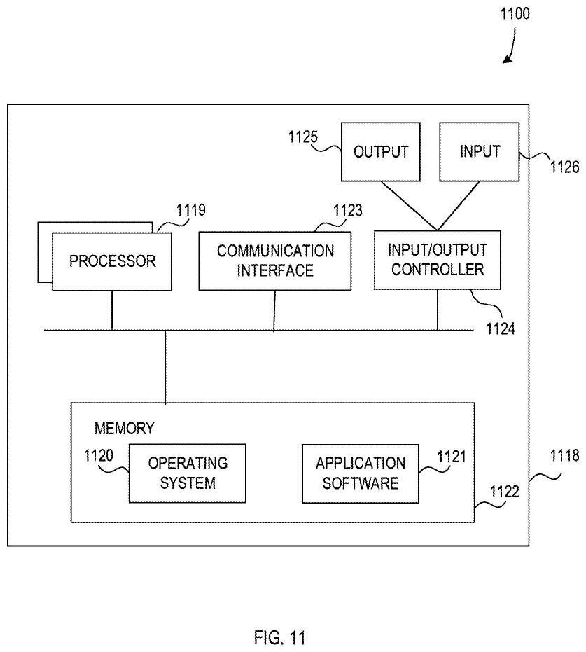

The present disclosure is operable with a computing apparatus according to an example as a functional block diagram 1100 in FIG. 11. In an example, components of a computing apparatus 1118 may be implemented as a part of an electronic device according to one or more examples described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hardcoded machine. Platform software comprising an operating system 1120 or any other suitable platform software may be provided on the apparatus 1118 to enable application software 1121 to be executed on the device. According to an example, enabling users to manage and analyze performance of transaction blocking schemes as described herein may be accomplished by software, hardware, and/or firmware.

Computer executable instructions may be provided using any computer-readable media that are accessible by the computing apparatus 1118. Computer-readable media may include, for example, computer storage media such as a memory 1122 and communications media. Computer storage media, such as a memory 1122, include volatile and non-volatile, removable and non-removable media implemented in any method or technology for storage of information such as computer-readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer-readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1122) is shown within the computing apparatus 1118, it will be appreciated by a person skilled in the art, that the storage may be distributed or located remotely and accessed via a network or other communication link (e.g. using a communication interface 1123).

The computing apparatus 1118 may comprise an input/output controller 1124 configured to output information to one or more output devices 1125, for example a display or a speaker, which may be separate from or integral to the electronic device. The input/output controller 1124 may also be configured to receive and process an input from one or more input devices 1126, for example, a keyboard, a microphone, or a touchpad. In one example, the output device 1125 may also function as the input device. An example of such a device may be a touch sensitive display. The input/output controller 1124 may also output data to devices other than the output device, e.g. a locally connected printing device. In some examples, a user may provide input to the input device(s) 1126 and/or receive output from the output device(s) 1125.

The functionality described herein can be performed, at least in part, by one or more hardware logic components. According to an example, the computing apparatus 1118 is configured by the program code when executed by the processor 1119 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in a plurality of ways, including from input devices such as a keyboard or pointing device, via gesture input, proximity input (such as by hovering), and/or via voice input.

Examples of the disclosure may be described in the general context of computer executable instructions, such as program modules, executed by one or more computers or other devices in software, firmware, hardware, or a combination thereof. The computer executable instructions may be organized into one or more computer executable components or modules. Generally, program modules include, but are not limited to, routines, programs, objects, components, and data structures that perform particular tasks or implement particular abstract data types. Aspects of the disclosure may be implemented with any number and/organization of such components or modules. For example, aspects of the disclosure are not limited to the specific computer executable instructions or the specific components or modules illustrated in the figures and described herein. Other examples of the disclosure may include different computer executable instructions or components having more or less functionality than illustrated and described herein.

In examples involving a general purpose computer, aspects of the disclosure transform the general purpose computer into a special purpose computing device when configured to execute the instructions described herein.

An example system for intelligently controlling resolution seeking inquiries comprises at least one processor, and at least one memory comprising computer program code. The computer program code causes the at least one processor to receive a data file including natural language from a client drafted inquiry; parse natural language data fields of the data file to identify at least one issue described by client drafted natural language; responsive at least to metadata of the data file and the identified at least one issue, determine parameters and context corresponding to the identified at least one issue; and create an electronic case file comprising at least part of the data file and an identification of the identified at least one issue. The creation of the electronic case file triggers further execution of the computer code that causes the at least one processor to select at least one agent of a plurality of agents for assignment to the created electronic case file; receive, from one or more agent data repositories, data quantifying qualifications of ones of the plurality of agents; receive, from the one or more agent data repositories, data quantifying conditions of ones of the plurality of agents; and execute a test that outputs selected ones of the plurality of agents for the created electronic case file based at least on the determined parameters and context of the identified at least one issue, and the data quantifying the qualifications and the data quantifying the conditions of ones of the plurality of agents. The computer program code also causes the at least one processor to update a data field of the electronic case file indicating the selected at least one agent, wherein the selected at least one agent is configured to resolve the identified at least one issue.

A computerized method for intelligently controlling resolution seeking inquiries includes receiving, by one or more processors, a data file including natural language from an inquiry drafted by a client; parsing, by the one or more processors, natural language fields of the data file to identify at least one issue described by client drafted natural language; responsive at least to metadata of the data file and the identified at least one issue, determining, by the one or more processors, parameters and context corresponding to the identified at least one issue; creating, by the one or more processors, an electronic case file comprising at least part of the data file and identifying the at least one issue, wherein creation of the electronic case file triggers the one or more processors select at least one agent of a plurality of agents for assignment to the created electronic case file; receiving, by the one or more processors from one or more data repositories, data quantifying qualifications of ones of the plurality of agents; receiving, by the one or more processors from the one or more data repositories, data quantifying conditions of ones of the plurality of agents; and executing, by the one or more processors, a test that outputs selected ones of the plurality of agents for the created electronic case file based at least on the context and the determined parameters of the identified at least one issue, and the data quantifying the qualifications and the data quantifying conditions. The method also updates, by the one or more processors, a data field of the electronic case file indicating the selected at least one agent, wherein the selected at least one agent is configured to resolve the identified at least one issue.

One or more non-transitory computer storage media have computer executable instructions for intelligently controlling resolution seeking inquiries that, upon execution by at least one processor, cause the at least one processor to at least: receive a data file including information from a client drafted inquiry; parse natural language fields of the data file to identify at least one issue described by client drafted natural language; responsive at least to metadata of the data file and the identified at least one issue, determine parameters and context corresponding to the identified at least one issue; create an electronic case file comprising at least part of the data file and identifying the at least one issue, wherein creation of the electronic case file triggers the at least one processor to select at least one agent of a plurality of agents for assignment to the created electronic case file; receive from one or more data repositories, data quantifying qualifications of ones of the plurality of agents; receive, from the one or more data repositories, data quantifying conditions of ones of the plurality of agents; and execute a test that outputs selected ones of the plurality of agents for the created electronic case file based at least on: the context and the determined parameters of the identified at least one issue, and the data quantifying the qualifications and the data quantifying conditions. The computer executable instructions, upon execution by at least one processor, further cause the at least one processor to update a data field of the electronic case file indicating the selected at least one agent, wherein the selected at least one agent is configured to resolve the identified at least one issue.

Alternatively, or in addition to the other examples described herein, examples include any combination of the following:
wherein the computer program code further causes the at least one processor to: receive, from one or more historical data repositories, historical data files drafted by other clients describing historical inquires and corresponding historical electronic case files created respectively from the historical data files; convert the received historical data files and the corresponding historical electronic case files into training data at least via execution of computer training code that causes the at least one processor to: identify a plurality of issues from historical issues identified in the historical electronic case files based on the received historical data files and the corresponding historical electronic case files, and identify context and parameters associated respectively with the historical issues based on the received historical data files and the corresponding historical electronic case files, store, in the one or more historical data repositories, the converted training data; and based on at least some of the training data, modify the computer program code of the at least one memory for subsequently received data files drafted by other clients.
wherein the computer program code further causes the at least one processor to receive, from one or more historical data repositories, historical electronic case files and corresponding resolution ratings that rate success factors associated respectively with historical issues of respective historical electronic case files; convert the received historical electronic case files and corresponding resolution ratings into training data at least via execution of computer training code that causes the at least one processor to: quantify a plurality of agent qualifications based on which agent qualifications contributed to which resolution ratings of respective historical issues, and quantify a plurality of agent conditions based on which agent condition contributed to which resolution ratings of respective historical issues of the training data; and store, in the one or more historical data repositories, the converted training data; and based on at least some of the training data, modify the computer program code of the at least one memory for subsequently received data files drafted by other clients.
wherein the computer program code further causes the at least one processor to: receive feedback data corresponding to the electronic case file, the feedback including at least: parsing resolution ratings, issue identification ratings, parameters determination ratings, issue group definition ratings, and agent selection ratings; convert at least some of the feedback data into training data; and store, in the one or more historical data repositories, the converted training data; and based on at least some of the training data, modify the computer program code of the at least one memory for subsequently received data files.
wherein the context indicates a regulatory classification associated with the identified at least one issue, wherein the determined parameters include regulatory rules associated with the regulatory classification responsive to the context indicating the regulatory classification, and wherein at least one of the data quantifying conditions is based on the regulatory rules of the regulatory classification.
wherein the identified at least one issue described by the client is a plurality of identified issues, and wherein the computer program code further causes the at least one processor to: determine parameters and context corresponding to each of the plurality of identified issues; and generate at least one issue group from the plurality of identified issues at least via evaluation of the parameters and the context corresponding to each of the plurality of identified issues to group ones of the plurality of identified issues having a score indicative of a same agent being configured to resolve the ones of the plurality of identified issues; and create another electronic case file comprising at least part of the data file and identification of the ones of the plurality of identified issues in the generated at least one issue group.
wherein the context indicates a priority level associated with the electronic case file, wherein the priority level is based on one or more of: a quality of service level associated with the client; and a type of service interruption associated with the identified at least one issue.
wherein the selected at least one agent is one of: an individually identified agent, two or more individually identified agents; an identified agent team comprising a plurality of agents configured to resolve the identified at least one issue; an identified region of agents comprising a plurality of agents configured to resolve the identified at least one issue; and a third-party agent comprising one or more agents configured to resolve the identified at least one issue.
wherein the context indicates one or more of: a tone of language from the client drafted inquiry, and a sophistication level of the language from the client drafted inquiry; and wherein the quantified conditions of the selected ones of the plurality of agents indicate a personality type or attitude score determined to correspond to the indicated context.
wherein the client drafted inquiry is a form free drafted email, and wherein the selected at least one agent is selected by software executing on the at least one processor free from human input during a time period starting when the client drafted inquiry was received by a case management system and ending when the electronic case file indicating the selected at least one agent is sent to the case management system.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all the stated problems or those that have any or all the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer-readable medium, in hardware programmed or designed to perform the operations, or both. For example, aspects of the disclosure may be implemented as a system-on-a-chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for intelligently controlling resolution seeking inquiries, the system comprising:
at least one processor; and
at least one memory comprising computer program code, the at least one memory and the computer program code causes the at least one processor to:
receive a data file including natural language from a client drafted inquiry;
parse natural language data fields of the data file to identify at least one issue described by client drafted natural language;
responsive at least to metadata of the data file and the identified at least one issue, determine parameters and context corresponding to the identified at least one issue;
create an electronic case file comprising at least part of the data file and an identification of the identified at least one issue, wherein creation of the electronic case file triggers further execution of the computer program code that causes the at least one processor to select at least one agent of a plurality of agents for assignment to the created electronic case file;
receive, from one or more agent data repositories, data quantifying qualifications of ones of the plurality of agents;
receive, from the one or more agent data repositories, data quantifying conditions of ones of the plurality of agents;
execute a test that outputs selected ones of the plurality of agents for the created electronic case file based at least on:
the determined parameters and context of the identified at least one issue, and
the data quantifying qualifications and the data quantifying conditions of ones of the plurality of agents; and
update a data field of the electronic case file indicating the selected at least one agent, wherein the selected at least one agent is configured to resolve the identified at least one issue.

2. The system of claim 1, wherein the computer program code further causes the at least one processor to:
receive, from one or more historical data repositories, historical data files drafted by other clients describing historical inquires and corresponding historical electronic case files created respectively from the historical data files;
convert the received historical data files and the corresponding historical electronic case files into training data at least via execution of computer training code that causes the at least one processor to:
identify a plurality of issues from historical issues identified in the historical electronic case files based on the received historical data files and the corresponding historical electronic case files, and
identify context and parameters associated respectively with the historical issues based on the received historical data files and the corresponding historical electronic case files,
store, in the one or more historical data repositories, the converted training data; and
based on at least some of the training data, modify the computer program code of the at least one memory for subsequently received data files drafted by other clients.

3. The system of claim 1, wherein the computer program code further causes the at least one processor to:
receive, from one or more historical data repositories, historical electronic case files and corresponding resolution ratings that rate success factors associated respectively with historical issues of respective historical electronic case files;
convert the received historical electronic case files and corresponding resolution ratings into training data at least via execution of computer training code that causes the at least one processor to:
quantify a plurality of agent qualifications based on which agent qualifications contributed to which resolution ratings of respective historical issues, and
quantify a plurality of agent conditions based on which agent condition contributed to which resolution ratings of respective historical issues of the training data; and
store, in the one or more historical data repositories, the converted training data; and
based on at least some of the training data, modify the computer program code of the at least one memory for subsequently received data files drafted by other clients.

4. The system of claim 1, wherein the computer program code further causes the at least one processor to:
receive feedback data corresponding to the electronic case file, the feedback data including one or more of the following: parsing resolution ratings, issue identification ratings, parameters determination ratings, issue group definition ratings, and agent selection ratings;
convert at least some of the feedback data into training data;
store, in the one or more historical data repositories, the converted training data; and
based on at least some of the training data, modify the computer program code of the at least one memory for subsequently received data files.

5. The system of claim 1, wherein the context indicates a regulatory classification associated with the identified at least one issue,
wherein the determined parameters include regulatory rules associated with the regulatory classification responsive to the context indicating the regulatory classification, and
wherein at least one of the data quantifying conditions is based on the regulatory rules of the regulatory classification.

6. The system of claim 1, wherein the identified at least one issue described by the client is a plurality of identified issues, and wherein the computer program code further causes the at least one processor to:
determine parameters and context corresponding to each of the plurality of identified issues; and
generate at least one issue group from the plurality of identified issues at least via evaluation of the parameters and the context corresponding to each of the plurality of identified issues to group ones of the plurality of identified issues having a score indicative of a same agent being configured to resolve the ones of the plurality of identified issues; and
create another electronic case file comprising at least part of the data file and identification of the ones of the plurality of identified issues in the generated at least one issue group.

7. The system of claim 1, wherein the context indicates a priority level associated with the electronic case file, wherein the priority level is based on one or more of:
a quality of service level associated with the client; and
a type of service interruption associated with the identified at least one issue.

8. The system of claim 1, wherein the selected at least one agent is one of the following:
an individually identified agent;
two or more individually identified agents;
an identified agent team comprising a plurality of agents configured to resolve the identified at least one issue;
an identified region of agents comprising a plurality of agents configured to resolve the identified at least one issue; and
a third-party agent comprising one or more agents configured to resolve the identified at least one issue.

9. A computerized method for intelligently controlling resolution seeking inquiries, the method comprising:
receiving, by one or more processors, a data file including natural language from an inquiry drafted by a client;
parsing, by the one or more processors, natural language fields of the data file to identify at least one issue described by client drafted natural language;
responsive at least to metadata of the data file and the identified at least one issue, determining, by the one or more processors, parameters and context corresponding to the identified at least one issue;
creating, by the one or more processors, an electronic case file comprising at least part of the data file and identifying the at least one issue, wherein creation of the electronic case file triggers the one or more processors select at least one agent of a plurality of agents for assignment to the created electronic case file;
receiving, by the one or more processors from one or more data repositories, data quantifying qualifications of ones of the plurality of agents;
receiving, by the one or more processors from the one or more data repositories, data quantifying conditions of ones of the plurality of agents;
executing, by the one or more processors, a test that outputs selected ones of the plurality of agents for the created electronic case file based at least on:
the context and the determined parameters of the identified at least one issue, and
the data quantifying qualifications and the data quantifying conditions; and
updating, by the one or more processors, a data field of the electronic case file indicating the selected at least one agent, wherein the selected at least one agent is configured to resolve the identified at least one issue.

10. The computerized method of claim 9, further comprising:
receiving, by one or more processors from one or more historical data repositories, historical data files drafted by other clients including at least historical data files drafted by other clients describing historical inquires and corresponding historical electronic case files created respectively from the historical data files;
converting the received historical data files and the corresponding historical electronic case files into training data;
based at least on the training data, identifying, by the one or more processors, a plurality of issues and from historical issues identified in the historical electronic case files;
based at least on the training data, identifying, by the one or more processors, parameters associated respectively with the historical issues;
based at least on the training data, identifying context and parameters associated respectively with historical issue groups of the historical electronic case files; and
storing, in one or more data repositories, the identified plurality of issues, the identified parameters associated respectively with the historical issues, and the identified context and parameters associated respectively with historical issue groups.

11. The computerized method of claim 9, further comprising:
receiving, by one or more processors from one or more historical data repositories, historical electronic case files and corresponding resolution ratings that rate success factors associated respectively with historical issues of respective historical electronic case files;
converting the received historical electronic case files and corresponding resolution ratings into training data;
based at least on the training data, quantifying, by the one or more processors, a plurality of agent qualifications based on which agent qualifications contributed to which resolution ratings of respective historical issues of the training data;
based at least on the training data, quantifying, by the one or more processors, a plurality of agent conditions based on which agent condition contributed to which resolution ratings of respective historical issues of the training data; and
storing, in one or more data repositories, data quantifying the plurality of agent qualifications and data quantifying the plurality of agent conditions.

12. The computerized method of claim 9, further comprising:
receiving, by the one or more processors, feedback data corresponding to the electronic case file, the feedback including one or more of the following: parsing resolution ratings, issue identification ratings, parameters determination ratings, issue group definition ratings, and agent selection ratings;
converting at least some of the feedback data into training data; and
based on at least some of the training data, modifying, by the one or more processors, at least one of the parsing, the determining, the defining, the creating, and the testing for a subsequent data file including natural language from an inquiry drafted by another client.

13. The computerized method of claim 9, wherein the context indicates a regulatory classification associated with the identified at least one issue,
wherein the determined parameters include regulatory rules associated with the regulatory classification responsive to the context indicating the regulatory classification, and
wherein at least one of the data quantifying conditions is based on the regulatory rules of the regulatory classification.

14. The computerized method of claim 9, wherein the identified at least one issue described by the client is a plurality of identified issues, the method further comprising:
determining, by the one or more processors, parameters and context corresponding to each of the plurality of identified issues;
generating at least one issue group from the plurality of identified issues at least by evaluating the parameters and the context corresponding to each of the plurality of identified issues and grouping ones of the plurality of identified issues having a score indicating that a same agent is configured to resolve the ones of the plurality of identified issues; and
creating, by the one or more processors, another electronic case file comprising at least part of the data file and identifying the ones of the plurality of identified issues in the generated at least one issue group.

15. The computerized method of claim 9, wherein the context indicates a priority level associated with the electronic case file, wherein the priority level is based on one or more of:
a quality of service level associated with the client; and
a type of service interruption associated with the identified at least one issue.

16. The computerized method of claim 9, wherein the selected at least one agent is one of the following:
an individually identified agent;
two or more individually identified agents;
an identified agent team comprising a plurality of agents configured to resolve the identified at least one issue;
an identified region of agents comprising a plurality of agents configured to resolve the identified at least one issue; and
a third-party agent comprising one or more agents configured to resolve the identified at least one issue.

17. One or more non-transitory computer storage media having computer executable instructions for intelligently controlling resolution seeking inquiries, upon execution by at least one processor, cause the at least one processor to at least:
receive a data file including information from a client drafted inquiry;
parse natural language fields of the data file to identify at least one issue described by client drafted natural language;
responsive at least to metadata of the data file and the identified at least one issue, determine parameters and context corresponding to the identified at least one issue;
create an electronic case file comprising at least part of the data file and identifying the at least one issue, wherein creation of the electronic case file triggers the at least one processor to select at least one agent of a plurality of agents for assignment to the created electronic case file;
receive from one or more data repositories, data quantifying qualifications of ones of the plurality of agents;
receive, from the one or more data repositories, data quantifying conditions of ones of the plurality of agents;
execute a test that outputs selected ones of the plurality of agents for the created electronic case file based at least on:
the context and the determined parameters of the identified at least one issue, and
the data quantifying the qualifications and the data quantifying conditions; and
update a data field of the electronic case file indicating the selected at least one agent, wherein the selected at least one agent is configured to resolve the identified at least one issue.

18. The one or more non-transitory computer storage media of claim 17 having further computer executable instructions causing the at least one processor to further:
receive, from one or more historical data repositories, historical data files drafted by other clients describing historical inquires, corresponding historical electronic case files created respectively from the historical data files, and corresponding resolution ratings that rate success factors associated respectively with historical issues of respective historical electronic case files;
convert the received historical data files, the corresponding historical electronic case files, and corresponding resolution ratings into training data at least via execution of computer training code that causes the at least one processor to:
identify a plurality of issues from historical issues identified in the historical electronic case files based on the received historical data files and the corresponding historical electronic case files,
identify context and parameters associated respectively with the historical issues based on the received historical data files and the corresponding historical electronic case files,
quantify a plurality of agent qualifications based on which agent qualifications contributed to which resolution ratings of respective historical issues, and
quantify a plurality of agent conditions based on which agent condition contributed to which resolution ratings of respective historical issues of the training data;
store, in the one or more historical data repositories, the converted training data; and
based on at least some of the training data, modify the computer executable instructions for subsequently received data files drafted by other clients.

19. The one or more non-transitory computer storage media of claim 17, wherein the context indicates one or more of:
a tone of language from the client drafted inquiry, and
a sophistication level of the language from the client drafted inquiry; and
wherein the quantified conditions of the selected ones of the plurality of agents indicate a personality type or attitude score determined to correspond to the context.

20. The one or more non-transitory computer storage media of claim 17, wherein the client drafted inquiry is a form free drafted email, and
wherein the selected at least one agent is selected by software executing on the at least one processor free from human input during a time period starting when the client drafted inquiry was received by a case management system and ending when the electronic case file indicating the selected at least one agent is sent to the case management system.
